(19) United States
(12) Patent Application Publication
(10) Pub. No.: US 2026/0085238 A1
(43) Pub. Date: Mar. 26, 2026

(54) METHODS AND DEVICES FOR SINTERING CERAMIC PHOSPHOR CONVERTER UNDER PRESSURE

(71) Applicant: Lumileds LLC, San Jose, CA (US)

(72) Inventors: Peter Josef Schmidt, Aachen (DE); Christoph Martiny, Aachen (DE); Oliver Steigelmann, Aachen (DE); Philipp Geiger, Aachen (DE)

(73) Assignee: Lumileds LLC, San Jose, CA (US)

(21) Appl. No.: 18/897,655

(22) Filed: Sep. 26, 2024

(51) Int. Cl. C09K 11/77; C04B 35/597; C04B 35/63; C04B 35/645

(52) U.S. Cl. CPC C09K 11/77348; C04B 35/597; C04B 35/63; C04B 35/645; C04B 2235/3873

(57) ABSTRACT

An amber emitting nitride ceramic phosphor may be directly sintered under pressure to improve the resulting compositional gradient. As a result mechanical thinning of the ceramic is less necessary. The ceramic also comes out more chemically stable, allowing for the example the application of a dichroic layer which can improve color point in the final light emitting device. The inventive process is cheaper than conventional production methods and may results in a phosphor with better quantum efficiency.

### FIELD OF THE INVENTION

The invention relates generally to phosphors, particularly methods and devices including thin amber emitting nitride ceramic phosphors.

### BACKGROUND

The general illumination industry has witnessed remarkable advancements in technology, with one breakthrough being the invention of Light-Emitting Diodes (LEDs). This innovation has transformed the way we perceive and experience general illumination, offering improved efficiency, durability, and versatility. Developed as a response to the limitations of traditional light source, LEDs have become a staple feature in areas like modern grounded vehicles, providing enhanced safety, aesthetics, and functionality. In particular, automotives often use amber light emitting devices for signaling. These light emitting devices may use phosphors to achieve their amber color, such as ceramic phosphors.

Direct sintering of thin (<300 μm) amber emitting nitride ceramic wafers may result in chemical interactions of the ceramics with setter components that are applied to stack the ceramics in the firing furnace. Such interactions with setter components (which are made of, for example, refractory ceramics or metals like silicon nitride, boron nitride, molybdenum or tungsten) can easily lead to material gradients in the sintered ceramic with the wanted composition in the center region of the ceramic.

To mitigate these gradient issues amber emitting nitride ceramics can be thinned by mechanical means such as grinding to remove the outer regions with unwanted phase compositions. Due to the high hardness of nitride ceramics the material removal process is rather costly. Furthermore, sintering of thicker than needed ceramic parts limits furnace loading and leads to high starting material consumption.

It would therefore be desirable to process thinner amber emitting nitride ceramics without the need for excessive and costly material removal, cleaning, and so on.

### SUMMARY

Embodiments of the invention solve the aforementioned issues by providing a process that allows the direct sintering of thin amber emitting nitride ceramics showing no or only very limited compositional gradients. This leads to a more economic production as expensive mechanically thinning is not required. The resulting ceramics may also be more chemically stable compared to those resulting from conventional processes.

The thinner ceramics formed from such processes also allow the application of dichroic coating layers that can be used to further improve the conversion efficiency of the claimed nitride ceramics.

### BRIEF DESCRIPTION OF THE DRAWINGS

FIG. 1 shows a cross-section micrograph of a conventional amber emitting nitride ceramic.

FIG. 2 shows a powder diffraction pattern of amber emitting nitride ceramic after etching and powderizing, according to embodiments of the invention.

FIG. 3 shows a cross-section micrograph of an amber emitting nitride ceramic, according to embodiments of the invention.

FIG. 4 shows a flow chart of a process for obtaining a ceramic phosphor according to embodiments of the invention.

FIG. 5 shows CIELUV color coordinates of pcLEDs with (grey squares) and without (black circles) dichroic filter elements, according to embodiments of this invention.

FIG. 6 schematically illustrates a light emitting device with a ceramic phosphor according to embodiments of this invention.

FIG. 7 schematically illustrates a light emitting device with a ceramic phosphor and dichroic element, according to embodiments of this invention.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention.

As used in this specification and the appended claims, the singular forms “a,” “an,” and “the” include plural referents unless the context clearly indicates otherwise. Also, the term “parallel” is intended to mean “substantially parallel” and to encompass minor deviations from parallel geometries. The term “vertical” refers to a direction parallel to the force of the earth's gravity. The term “horizontal” refers to a direction perpendicular to “vertical.” The term “on” means to be disposed to overlap (e.g., vertically) and/or to be directly in contact with.

Amber emitting nitride phosphors are often sintered in ambient pressure. U.S. Patent U.S. Ser. No. 11/031,529B2 describes amber emitting nitride ceramics comprising various crystalline phases such as 258 luminescent main phase, 3334 phase, 1710 phase and BOSE phase. It describes ambient pressure sintering of fine powders of (Ba₁₋ₓSrₓ)_{2-z}Si_{5-y}O_{4y}N_{8-4y}:Eu_{z} with a specified specific surface area and a method of treating as-sintered ceramics under high nitrogen gas pressure to reduce the amount of unwanted 3334 phase to improve stability and conversion efficiency of the amber emitting nitride ceramics. The entirety of U.S. Patent U.S. Ser. No. 11/031,529B2 of Lumileds, dated Jun. 8, 2021 and titled “Wavelength Converting Material For A Light Emitting Device,” is incorporated by reference herein.

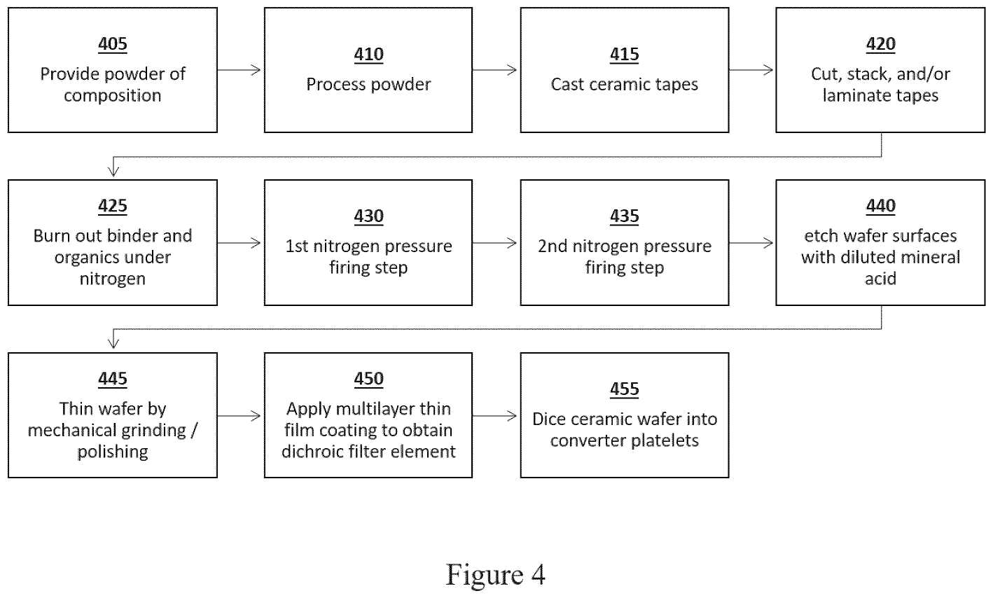

According to embodiments of the invention, FIG. 4 shows an overview of a process to obtain amber emitting nitride ceramic converters. The process includes a tape casting and sintering method for amber emitting nitride ceramics without compositional gradients. One or more of these steps may be omitted, even if not explicitly stated, according to the desired use case and characteristics of the ceramic converter.

At 405 provide a powder of composition. In order to obtain a low or no compositional gradient ceramic wafer, the oxygen concentration and the specific surface area of the ceramic precursor powder applied for processing of the ceramic nitride converter should be kept within certain ranges to meet the desired properties. On the other hand, the oxygen concentration should not be too low as this may cause the ceramics not to sinter, and not too high as to unduly increase the amount of phases that limit conversion efficiencies and reduce the chemical stability of the ceramics.

The precursor used for form the ceramic wafer may have the following properties: a power precursor of composition (Ba₁₋ₓSrₓ)_{2-z}Si_{5-y}O_{4y}N_{8-4y}:Eu_{z} with 0.2≤x≤0.5, 0.015≤y≤0.1, 0.004≤z≤0.02 and a specific surface area in the 1.5-2.4 m²/g range measured with a gas adsorption method according to Brunauer, Emmett and Teller (BET method). Control of the y parameter is critical for both the sintering behavior of the nitride ceramics and the desired phase composition, resulting in an oxygen concentration in the 0.3-1.3 wt % range of the precursor, such as 0.3-0.90 wt %, such as 0.65-0.90 wt %. If y parameter is too low compared to the above range, the ceramic will not densify enough. If the y parameter is too high compared to the above range, this will result in too high concentration of secondary phases, resulting in a quantum inefficient ceramic wafer with limited stability. Preferably, the composition is chosen from the range (Ba₁ₓSrₓ)_{2-z}Si_{5-y}O_{4y}N_{8-4y}:Eu_{z} with 0.3≤x≤0.4, 0.04≤y≤0.07, 0.0075≤z≤0.01.

At 410 process the powder, for example by milling the powder in alcohol with dispersant and adding a binder and/or plasticizer.

At 415 cast the ceramic tapes, for example with a doctor blade system to obtain tapes with, for example a thickness in the 18-20 micron range after solvent evaporation.

At 420 the tapes are, stacked, laminated, and/or cut to decrease their size, to form ceramic green bodies with, for example, thicknesses in the 250-290 μm range. The ceramic green bodies may be stacked with setters between them in the furnace.

At 425 burn out binder and organics, e.g. in a furnace. This may be done at ambient pressure or lower than ambient pressure. Air may be excluded or partially excluded from the chamber during this process by the presence of nitrogen, which serves as a protective atmosphere to stop the ceramic green bodies from oxidizing. The atmosphere may also contain other nitrogen containing gas species like ammonia.

At 430 fire under nitrogen pressure for a first sintering. first sintering is done under nitrogen pressure in the range 0.5 to 2 MPa and at temperatures in the 1680-1750° C. range, for example from 1700-1750° C., for example from 1720-1750° C. Nitrogen pressure means pressure from nitrogen gas and/or gas which includes majority nitrogen. Because no silicon is being lost by reacting with e.g. setter plates (preferably made out of a refractory metal such as tantalum, molybdenum, niobium, or tungsten) during the pressure firing process, the obtained nitride ceramics are richer in silicon content compared to ceramics sintered without nitrogen pressure. As a consequence, more 1710 phase and less BOSE and 3334 phases are formed during this firing process.

At 435 fire under nitrogen pressure a second time. The additional firing step may be at a temperature in the 1400-1650° C. range under nitrogen pressure 50-100 MPa. In other words, the second firing step may be at a lower temperature and higher pressure than the first. After the second firing, the a typical composition of a nitrogen pressure sintered amber emitting nitride ceramic processed by the method described in this invention may be 85-90 wt % 258 luminescent main phase, 5-9 wt % 1710 phase (e.g., 6-8 wt %), 0.5-2 wt % 3334 phase, and 2-5 wt % BOSE phase. This may be the ultimate composition at the end of this entire process, although that is not required and the composition may be different. Compared to the composition after the first firing at 430, the 3334 phase after the second firing may be lower and the BOSE phase higher.

At 440 etch ceramic wafer surfaces with diluted mineral acid.

At 445 thin the ceramic wafer by mechanical grinding and/or polishing. This step may be skipped if a thinner wafer is not necessary and/or the phase accumulation at the thin layer is thin enough.

At 450 apply a multilayer thin film coating to obtain a dichroic filter element on the ceramic wafer. As the ceramic phosphor according to embodiments of this invention may be more stable compared to conventional ceramic phosphors, it may be made thinner. This thinness may result in leakage light from the LED, which may be undesirable. A dichroic coating will reduce or eliminate the leakage light. Also, in the conventional ceramic phosphors the less stable ceramic may locally change composition at the surfaces and may form pinholes within the dichroic coating, which may be undesirable. The more stable ceramic of this inventive process may prevent such defect formation. This step may be skipped if a dichroic coating is not needed.

At 455 dice the ceramic wafer (and the dichroic filter on it, if present) into converter platelets.

In contrast to amber emitting nitride ceramics produced according to the conventional methods the inventive amber emitting nitride ceramics show a specific microstructure with larger, scattering and non-amber luminescent BaSi₇N₁₀ (1710 phase, which may not show luminescence if excited with blue light and not show luminescence in the amber spectral range) ceramic grains present throughout the ceramic body and a grain size in the 1 to 20 μm range. Examples of this process and parts of this process conducted by the inventors are given below.

### (a) Pc Amber Precursor Powder Synthesis

In example embodiments of the invention, 94.1 g Si₃N₄(>98%), 0.895 g Eu₂O₃ (99.99%), 22.351 g SrH₂ (>99%) and 82.651 g BaH₂ (>99%) are mixed by ball milling and fired at 1450° C. in a mixture of hydrogen and nitrogen (5:95 ratio). After ball milling, the powder is washed with 2N HCl and rinsed with water and alcohol. After drying, a phase pure 258 powder is obtained (orthorhombic crystal lattice metric, refined lattice constants: a₀=5.759 Å, b₀=6.916 Å, c₀=9.364 Å, α₀=β₀=γ₀=90°).

### (b) Comparative Example

A ceramic nitride ceramic is prepared according to the method described in U.S. Patent U.S. Ser. No. 11/031,529B2 that is based on precursor powder granulation with polyvinyl alcohol, uniaxial pressing, sintering under ambient pressure, pregrinding, and HIP (hot isostatic pressing).

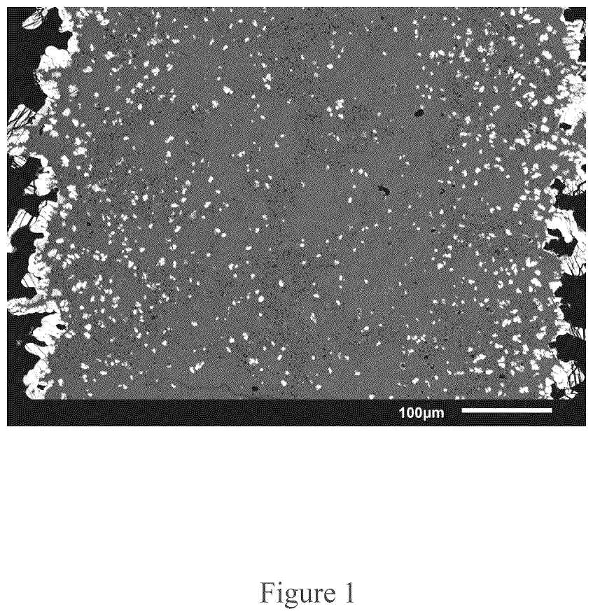

FIG. 1 shows a cross-section of an amber emitting nitride ceramic processed according to the comparative example (b) after ambient pressure sintering. The amber emitting nitride ceramic has thickness of ˜650 showing phase gradients from surface to center region. Light contrast phase: 3334, grey contrast phase: 258. The light contrast spots originate from 3334 phase that shows a low concentration in the center part of the ceramic and larger concentrations at the outer parts of the ceramic. The larger concentration of 3334 phase at the interfaces is caused by a loss of silicon during the firing process.

### (c) Example 1: Tape Casted Nitride Ceramic

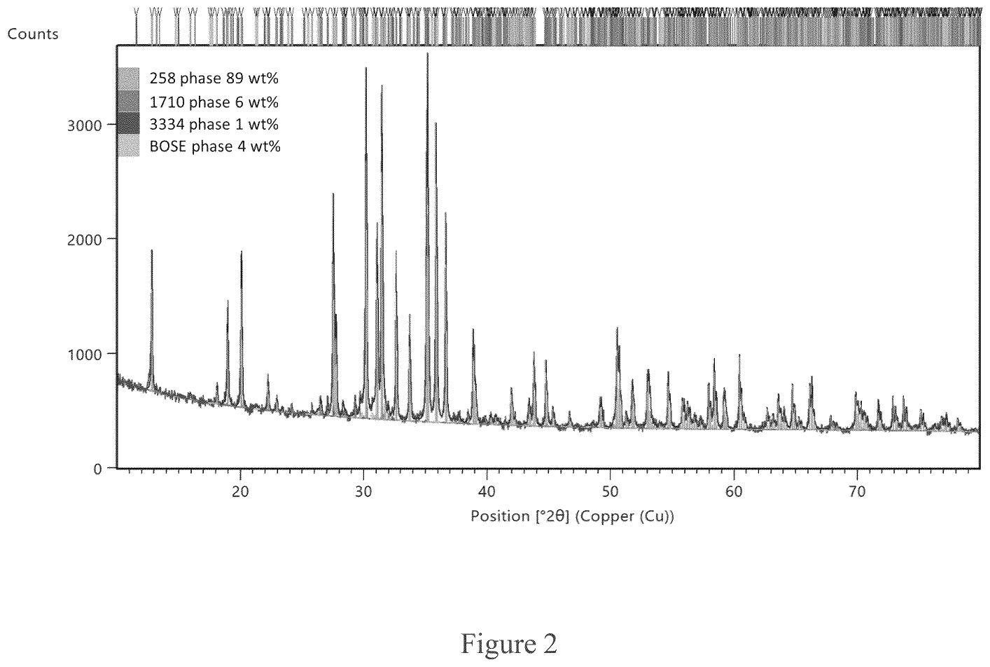

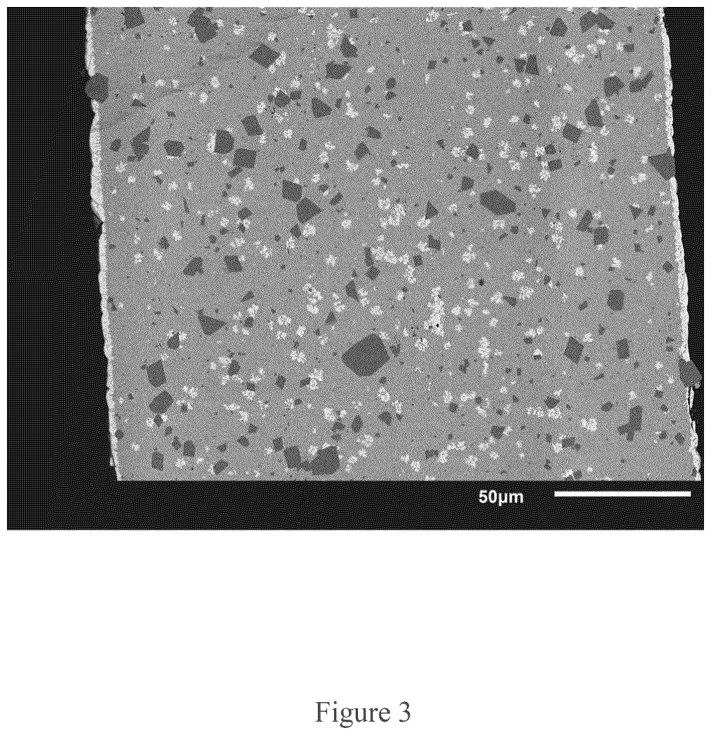

In example embodiments of the invention, a powder prepared according to the method described under (a) is dispersed in ethanol with a dispersant (Malialim) by means of ball milling. A polyvinylbutyral based binder and plasticizer system (Sekisui) is added after removing of the milling media and, after degassing, ceramic tapes are casted with a doctor blade system to obtain tapes with a thickness in the 18-20 μm range after solvent evaporation. Ceramic green bodies with thicknesses in the 250-290 μm range are obtained after stacking, laminating and cutting. Organic compounds are removed by a binder burn out step and the ceramic brown bodies are sintered at a temperature in the 1660-1720° C. range under nitrogen pressure (0.5-5 MPa). After an additional firing step at a temperature in the 1400-1650° C. range under nitrogen pressure (50-100 MPa), the formed sintering skin mainly comprising of 3334 phase (see FIG. 3) is removed by an etching step in diluted hydrochloric acid followed by rinsing with demineralized water and drying at 50° C. in vacuum. The obtained ceramic nitride wafer showing a phase composition according to the X-ray powder diffraction data shown in FIG. 2 and a thickness in the 200-240 μm range may then be further thinned mechanically to a thickness in the 100-160 μm range, such as from 100-130 μm, and a surface roughness Ra<0.35 μm. After final dicing of the larger wafers into smaller platelets with e.g. lateral dimensions of 1×1 mm², amber emitting nitride ceramic converter useable in a light emitting device may be obtained, according to embodiments of the invention. The tapecast amber ceramic material may have a density of 4.37 g/cm³, such as from 4-4.5 g/cm³, with a relative density of 98% or greater.

FIG. 2 shows a powder diffraction pattern of amber emitting nitride ceramic after etching and powderizing. FIG. 3 shows a cross-section view of a typical microstructure of an amber emitting nitride ceramic obtained after the firing steps described above. The thickness of the ceramic is ˜210 microns. The distribution of the various crystalline phases that form the ceramic microstructure is random with no phase accumulation except a thin layer of 3334 phase ((Ba,Sr)₃Si₃O₃N₄:Eu, non-luminescent) at the surfaces. Crystalline particles with a dark contrast with a size in the ˜1-20 micron range are made up by 1710 phase ((Ba,Sr)Si₇N₁₀:Eu, non-luminescent under blue light excitation), while smaller, aggregated particles with light contrasts are formed by 3334 phase and BOSE phase ((Ba,Sr)₂SiO₄:Eu). The 1710, BOSE, and 3334 grains sit within an emissive 258 matrix ((Ba,Sr)₂₋ₓSi_{5-y}O_{4y}N_{8-4y}:Euₓ, luminescent, represented by gray contrast). A ceramic grain is a particle in the ceramic matrix of a specific composition and crystal structure that forms grain boundaries to neighboring grains. The dark contrast crystalline particles of 1710 phase visible in FIG. 3 are some such grains. The outer 3334 layers can be removed by acid washing and/or grinding, leading to highly stable ceramics after drying.

### (d) Example 2: Tape Casted Amber Emitting Nitride Ceramic with Dichroic Filter Element

According to example embodiments of the invention, an amber emitting ceramic nitride ceramic processed according to the method described for example 1 with a thickness of 110 μm and a surface roughness Ra<0.35 μm is provided, along with an optical filter element comprising alternating layers of niobia Nb₂O₅ and silica SiO₂ deposited by a plasma enhanced sputtering process on one of the two large area surfaces. The following table shows the thicknesses of the individual layers with layer 1 being the first one deposited onto the ceramic surface of an amber emitting nitride ceramic wafer processed according to example 1.

| | | Thickness |
|---|---|---|
| Layer | Material | (nm) |
| 1 | Nb₂O₅ | 63 |
| 2 | SiO₂ | 27.32 |
| 3 | Nb₂O₅ | 56.08 |
| 4 | SiO₂ | 53.07 |
| 5 | Nb₂O₅ | 35.36 |
| 6 | SiO₂ | 58.7 |
| 7 | Nb₂O₅ | 41.97 |
| 8 | SiO₂ | 60.64 |
| 9 | Nb₂O₅ | 50.72 |
| 10 | SiO₂ | 63.84 |
| 11 | Nb₂O₅ | 60.97 |
| 12 | SiO₂ | 59.41 |
| 13 | Nb₂O₅ | 54.65 |
| 14 | SiO₂ | 73.09 |
| 15 | Nb₂O₅ | 55.92 |
| 16 | SiO₂ | 66.06 |
| 17 | Nb₂O₅ | 54.25 |
| 18 | SiO₂ | 61.59 |
| 19 | Nb₂O₅ | 58.45 |
| 20 | SiO₂ | 97.68 |
| 21 | Nb₂O₅ | 14.59 |

| | |
|---|---|
| Total Thickness | 1167.36 |

### e) Example 3

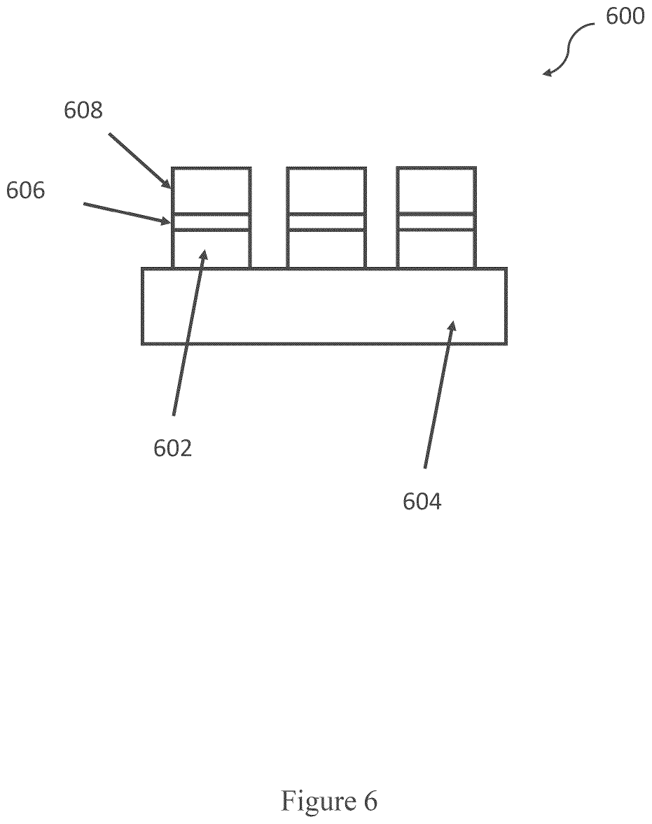

1. pcLED with converter of example 1: Amber emitting nitride ceramics are processed according to the method described for example 1 and thinned down to thicknesses of 90, 110, 130, and 150 μm by means of mechanical fine grinding. The ceramics are then diced into 1×1 mm² platelets and mounted onto blue emitting InGaN LED dies with a silicone glue layer. After covering the sidewalls of primary LED and converter platelets with a titania filled silicone layer, phosphor-converted (pc) amber emitting LEDs are being obtained. The pc amber LEDs are characterized by recording spectral power and intensity distribution data. FIG. 6 shows an example of this light emitting device 600, with LED dies 602 on a substrate 604, glue layer 606, and ceramic phosphor platelet (608).

2. pcLED with converter of example 2: Amber emitting nitride ceramics are processed according to the method described for example 1 and thinned down to thicknesses of 90, 110, 130, and 150 μm by means of mechanical fine grinding and coated with a dichroic filter element as described in example 2. PcLEDs are being built with the method as described above and the filter element forming the light exit surface of the pcLED. Again, the pc amber LEDs are characterized by recording spectral power and intensity distribution data.

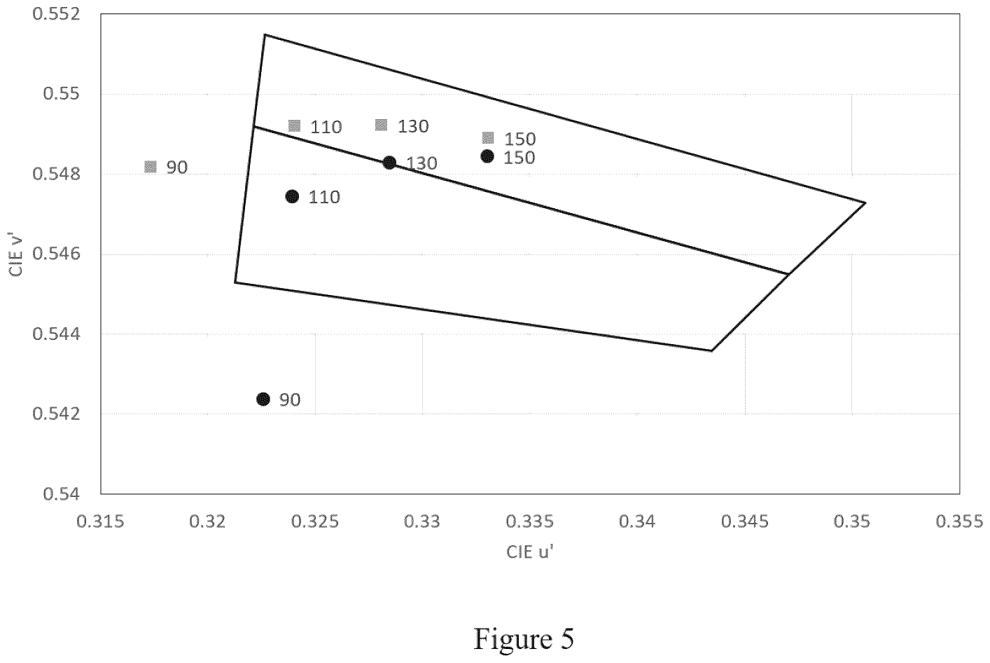

FIG. 5 show the CIELUV color space coordinates for the respective pcLEDs: CIELUV color coordinates of pcLEDs with (grey squares) and without (black circles) dichroic filter elements and for various converter platelet thicknesses (numbers shown in graph as micrometers). The black boxes represent color bin A and B of Lumileds automotive pc amber LEDs. It can be observed that the application of the inventive dichoric filter element leads to a higher color saturation (larger v′ value) compared to the reference LEDs. While only the converter with a thickness of 150 μm delivers a desirable color point (e.g. CIE1931 color coordinates with x from 0.5634-0.5901 and y from 0.4075-0.4315) without dichroic filter element, the color points for converters with a thickness of only 110 μm already show a saturated color points if a dichroic filter element has been applied.

In addition, the application of the dichroic filter element improves the pcLED flux output significantly, as shown for the pcLEDs with the color points shown in FIG. 5:

| convert | dichroic | luminous | amber |
|---|---|---|---|
| thickness | filter | flux | color |
| (μm) | element | (%) | bin |
| 150 | no | 100 | A |
| 150 | yes | 102 | A |
| 130 | no | 104 | A/B |
| 130 | yes | 106 | A |
| 110 | no | 107 | B |
| 110 | yes | 109 | A |
| 90 | no | 110 | outside range |
| 90 | yes | 114 | outside range |

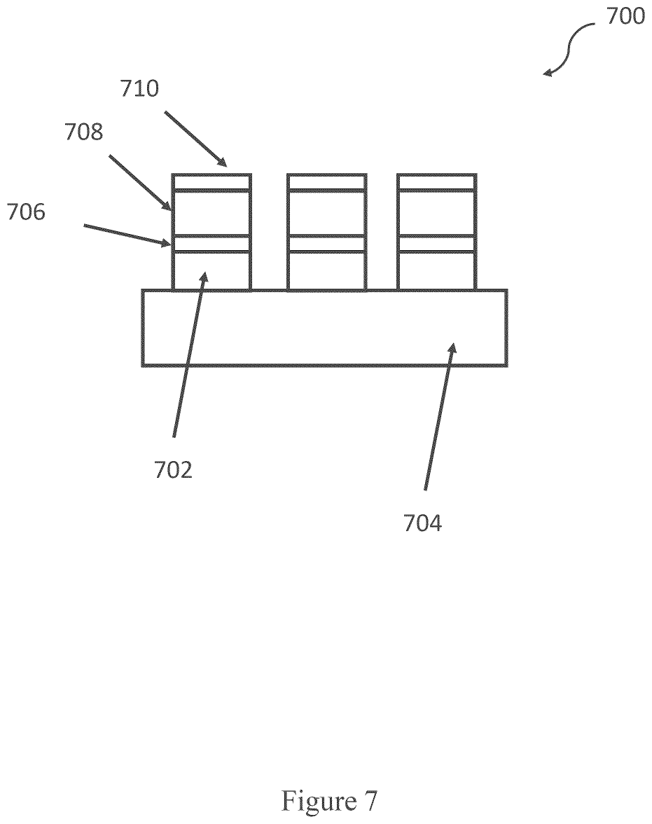

FIG. 7 shows an example of this light emitting device 700, with LED dies 702 on a substrate 704, glue layer 706, ceramic phosphor platelet 708, and dichroic filter 710.

The disclosures provided in this specification are intended to illustrate but not necessarily to limit the described implementation. As used herein, the term “implementation” means an implementation that serves to illustrate by way of embodiments but not limitation. The techniques described in the preceding text and figures can be mixed and matched as circumstances demand to produce alternative implementations. It will be apparent to those of ordinary skill in the art that numerous variations, changes, and substitutions of the embodiments described above can be made without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. All such alternatives will be apparent to one skilled in the art in light of this disclosure and are intended to fall within the scope of the appended claims.

What is claimed is:

1. A method for producing ceramic phosphor, comprising:
providing a precursor powder of composition (Ba₁₋ₓSrₓ)_{2-z}Si_{5-y}O_{4y}N_{8-4y}:Eu_{z}, with 0.2≤x≤0.5, 0.015≤y≤0.1, 0.004≤z≤0.02 and a Brunauer-Emmett-Teller (BET) surface area from 1.5-2.4 m²/g;
forming a body comprising the precursor powder; and
sintering the body under 0.5-2 MPa of pressure to form a ceramic phosphor structure.

2. The method of claim 1, wherein the ceramic phosphor structure is amber emitting.

3. The method of claim 1, wherein the pressure under which the body is sintered at 0.5-2 MPa is nitrogen pressure.

4. The method of claim 1, wherein the sintering of the body is done at 1680-1750° C.

5. The method of claim 1, wherein the body is formed on a setter plate comprising at least one of tantalum, molybdenum, niobium, and tungsten.

6. The method of claim 1, wherein the ceramic phosphor structure comprises grains of the 1710 phase that have diameters from 1-20 microns.

7. The method of claim 6, wherein the ceramic phosphor structure comprises grains of the 3334 phase and BOSE phase that are smaller than the grains of the 1710 phase.

8. The method of claim 1, further comprising mechanically thinning the ceramic phosphor structure.

9. The method of claim 1, wherein the ceramic phosphor structure has a thickness of 80-120 microns.

10. The method of claim 1, further comprising etching a sintering skin of the body by hydrochloric acid.

11. The method of claim 1, further comprising disposing a dichroic coating in direct contact with a surface of the ceramic phosphor structure.

12. The method of claim 1, wherein forming the body comprises forming a ceramic green body with a thickness of 250-290 micron.

13. The method of claim 1, wherein forming the body comprises adding a binder and a plasticizer to the precursor powder.

14. The method of claim 13, wherein forming the body comprises burning out the binder under nitrogen pressure.

15. The method of claim 1, further comprising dicing the ceramic phosphor structure into platelets.

16. A ceramic phosphor structure comprising:
an amber emitting nitride phosphor comprising 85-90 wt % of 258 phase, 5-9 wt % of 1710 phase, 0.5-2 wt % of 3334 phase, and 2-5 wt % of BOSE phase.

17. The ceramic phosphor structure of claim 16, wherein the 5-9 wt % of 1710 phase in the amber emitting nitride phosphor comprise grains in the 1-20 micron range.

18. The ceramic phosphor structure of claim 16, wherein the amber emitting nitride phosphor has a thickness of 80-120 microns.

19. The ceramic phosphor structure of claim 16, further comprising a dichroic coating disposed in direct contact with a surface of the amber emitting nitride phosphor.

20. The ceramic phosphor structure of claim 16, wherein the distribution of the 258 phase, 1710 phase, 3334 phase, and BOSE phase are random and show no gradients in the amber emitting nitride phosphor.
